(19) United States
(12) Patent Application Publication
(10) Pub. No.: US 2002/0113702 A1
(43) Pub. Date: Aug. 22, 2002

(54) System for detecting moving intruders

(76) Inventors: Alex Pakhomov, Ardsley, NY (US); Tim Goldburt, Chappaqua, NY (US); AI Sicignano, Mt. Kisco, NY (US)

Correspondence Address: Alex Pakhomov, 129 Euclid Avenue, Ardsley, NY, 10502, US

(21) Appl. No.: 09/788,237

(22) Filed: Feb. 16, 2001

(51) Int. Cl. G08B 13/00

(52) U.S. Cl. 340/566; 340/541

(57) ABSTRACT

A system for detecting a walking intruder has at least one sensor which senses the presence of intruders, and a processing unit connected with the sensor and operative for determining a plurality of parameters, analyzing the parameters, and making a decision from the determined value about a type of intruder present.

### BACKGROUND OF THE INVENTION

The present invention relates to a system for detecting intruders.

More particularly, it relates to a system for detecting an intruder, which can distinguish between intruders of different types. The known systems do provide detection of intruders, however they can not distinguish walking intruders of different types. In many instances it is very important not only to detect a presence of an intruder, but also to obtain information about the nature of the intruders.

### SUMMARY OF THE INVENTION

Accordingly, it is an object of present invention to provide a system of detecting intruders, which makes possible detection of walking intruders of different types.

In keeping with these objects and with others which will become apparent hereinafter, one feature of present invention resides, briefly stated, in a system for detecting an intruder, which has at least one sensor which sense the presence of intruders and at least a processing means connected with said sensor, said processing means being operative for determining a plurality of parameters, analyzing the parameters, and making a decision from a determined value as to what type of intruder is present.

When the system is designed in accordance with the present invention, it is possible to distinguish the intruders from one another. In particular, if the system is used for example during hunting, etc., the system allows to determine whether a detected object is a human being or an animal. This significantly increases the safety of hunting, to avoid hitting of a human being, instead of an animal.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a plurality of sensors of the inventive system covering a corresponding area; and

FIG. 2 is a view schematically showing a block diagram of the inventive system.

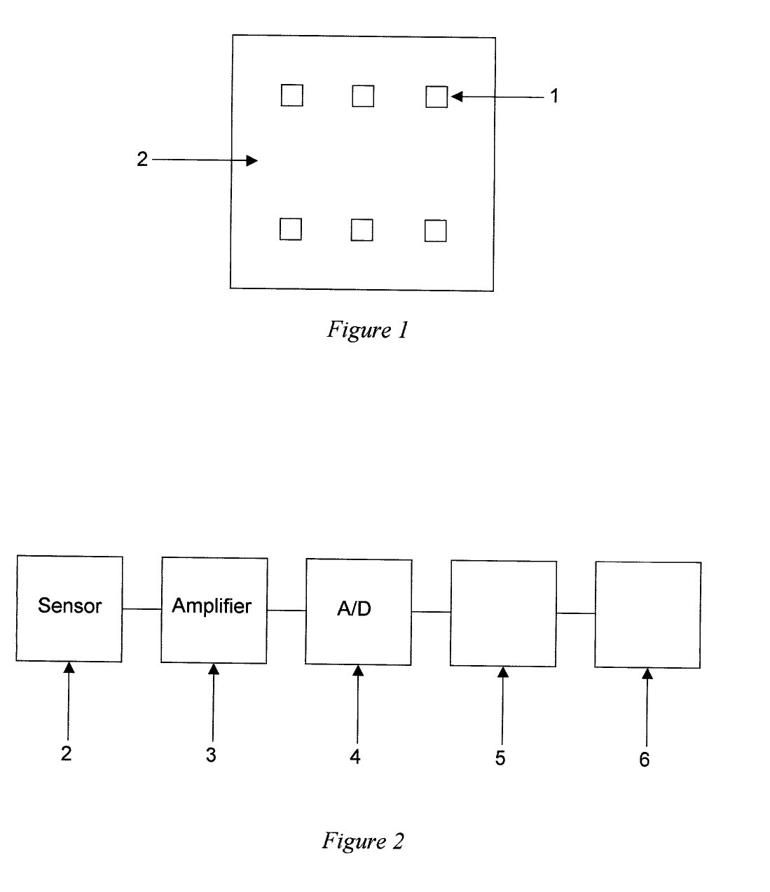

### DESCRIPTION OF THE PREFERRED EMBODIMENTS

A system for detecting an intruder in accordance with the present invention includes a plurality of sensors which are identified as a whole with reference numeral 1 and provided in an area 2. The sensors can be connected with one another and identified in FIG. 2 generally a sensing means 2. The sensing means 2 are connected with an amplifier 3, which in turn is connected to the analog/digital convertor 4. The analog-digital convertor is connected with a processing unit 5.

The central processing unit 5 is operative for determining a speed of movement of the intruder which can be represented as a number of steps per time unit or a time between the steps. It also determines a stability of movement of the intruder which is determined as a percentage of deviation of time intervals between the steps from an average interval. It also determines a level of a signal obtained from a sensor which is a level of an amplitude of voltage produced by the sensor. The sensor can be an acoustic sensor, a seismic sensor or a combined acoustic/seismic sensor which produces a signal in form of a voltage. Finally, the processing unit 5 determines a speed of change from one step to the other, or a speed of change of the amplitude.

The present invention can be used for example as a system for determining whether an intruder in an area is a human being or an animal, in particular a bear. The speed of movement of the human being is 0.25-1.5 seconds between the steps, while the speed of movement of the bear is 1.4-1.8 less time between the steps. The stability of the movement of a human being is 3-10%, while the stability of the movement of bear is 8-20%. A level of signal received from the sensor is for a human being 1.5-2.5 mV, while for the bear the level of signal is 4-6 times greater. Finally, the speed of change from step to step is 15-25% for a human being, and 30-50% for a bear. The central processing unit determines the numerical values of the above mentioned parameters. The specific operations for determining each of this parameters are not germaine to the present invention, and can be performed in any suitable way.

The central processing unit 5 is connected with an indicating device 6. The indicating device can be formed for example as a screen, in which as a result of the processing in the processing unit 5, it is shown a picture of a human being or a bear thus clearly indicating the type of the intruder. Also, on the screen there can be words saying “human being” or “bear”. Also, the indicating unit can be formed as an alarm which produces different alarms, for example a sound “human being” or “bear”, or alarms which do not include words, but instead signals of different pitch, type, etc.

Thus, the system in accordance with the present invention provides the possibility of distinguishing the type of the intruder for many purposes, including hunting purposes, etc.

It will be understood that each of the elements described above, or two or more together, may also find a useful application in other types of constructions differing from the types described above.

While the invention has been illustrated and described as embodied in system for detecting intruders, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for detecting a walking intruder, comprising at least one sensor which senses the presence of intruders; and processing means connected with said sensor, said processing means being operative for determining a plurality of parameters, analyzing the parameters, and making a decision from a determined value as to what type of intruder is present.

2. A system as defined in claim 1, wherein said processing unit is operative for determining parameters including a speed of movement of the intruder, a stability of movement of the intruder, a level of a signal produced by said at least one sensor as a result of intruding; and a speed of change of the signal from one step to the other.

3. A system as defined in claim 1; and further comprising indicating means connected with said processing means and operative for indicating a corresponding type of the intruder.
